(19) United States
(12) Patent Application Publication
(10) Pub. No.: US 2026/0130339 A1
(43) Pub. Date: May 14, 2026

(54) Tub with Interchangeable Mountable Structure

(71) Applicant: Adam's Specialty Products, LLC, Neenah, WI (US)

(72) Inventor: Adam John Keller, Fremont, WI (US)

(21) Appl. No.: 19/387,440

(22) Filed: Nov. 12, 2025

Related U.S. Application Data
(60) Provisional application No. 63/720,083, filed on Nov. 13, 2024.

(51) Int. Cl. A01K 1/03; E05C 19/00; E05D 3/02; E05D 7/10

(52) U.S. Cl. CPC A01K 1/03; E05C 19/007; E05D 3/02; E05D 7/1044

(57) ABSTRACT

A tub is provided having a body removably receiving interchangeable mountable structures such as a door proving selectable access to the tub interior. The body has four walls that each can have an opening formed therethrough. A frame with inner and outer pieces is supported on the body and cover the perimeter edge of a tub opening. The frame has barrels at one side and a retainer on the opposite side. The retainer has a lock flange with a lock edge. The mountable structure can have integrated pins at one side and a latch at the opposite side. The latch has a closing element with a latch edge and a release element. The pins can be vertically inserted down into the barrels to attach the mountable structure to the frame. The mountable structure is closed when the latch edge is engaged with the lock edge.

### CROSS-REFERENCE TO RELATED APPLICATIONS

This United States utility patent application claims priority on and the benefit of pending provisional application 63/720,083 filed November 13, 2024, the entire contents of which is hereby incorporated herein by reference.

### BACKGROUND OF THE INVENTION

### 1. Field of the Invention.

The present invention relates to animal enclosures, and more particularly to a tub with interchangeable mountable structures that are selectably opened to allow access to the interior of the tub.

### 2. Description of the Related Art.

Tubs are a common type of animal enclosure used by breeders, such as snake, reptile and rodent breeders. Tubs are commonly made of plastic and can have lids associated with them that can be removed to allow access to the interior of the tub from above.

One problem with a conventional tub is that there is no easy access to the tub without removing the lid. The tub may have to be removed from a rack or shelf in order to remove the lid. This problem can be solved by having a mountable structure that covers an opening on a tub sidewall. This would allow the user to access the interior of the tub while it remains in place on the rack or shelf. While such a solution may generally be known, none of the known existing side mountable structures have the unique advantages of the present invention.

Thus, there exists a need for a tub with interchangeable mountable structures that solves these and other problems.

### SUMMARY OF THE INVENTION

A tub is provided having a body removably receiving interchangeable mountable structures such as a door proving selectable access to the tub interior. The body has four walls that each can have an opening formed therethrough. A frame with inner and outer pieces is supported on the body and cover the perimeter edge of a tub opening. The frame has barrels at one side and a retainer on the opposite side. The retainer has a lock flange with a lock edge. The mountable structure can have integrated pins at one side and a latch at the opposite side. The latch has a closing element with a latch edge and a release element. The pins can be vertically inserted down into the barrels to attach the mountable structure to the frame. The mountable structure is closed when the latch edge is engaged with the lock edge.

There are many aspects of the present invention, which each can have unique and independent advantages, as set out in particular in the appended claims.

According to one advantage of the present invention, the accessory such as a mountable structure has integrated posts or pins, that allow the accessory to be installed and removed without tools. The pins can be attached to the mountable structure side at their respective pin tops. The mountable structure can be mounted on the frame by vertically inserting the pins downwards into the respective barrels. The mountable structure can be removed by moving the mountable structure in an upward direction to remove the pins from the barrels.

Related, the pins are downward oriented (relative to the tub) and are vertically received within the frame barrels. This is advantageous as the weight of the mountable structure assists (i.e., gravity assisted mounting) in keeping the mountable structure in place mounted to the frame. This is advantageous when the mountable structure is in the open state.

According to a still further advantage of the present invention, the pins can be integrally formed with the remainder of the mountable structure. This facilitates quick mounting and removal of the structure. It also eliminates the possibility of lost mounting hardware.

According to a still further advantage of the present invention, the pins are aligned with each other. Further, the pins are aligned along a pivot axis with respect to the frame when the mountable structure is mounted to the frame. That is, the mountable structure can swing about the pivot access relative to the body and frame when the mountable structure is in an unlocked state.

According to a further advantage of the present invention, the barrels and the retainer of the frame are on the front face of the frame, allowing the mountable structure to be fully seated in the frame when the latch is secured to the retainer. This is because of the offset nature of the pivot axis allows the mountable structure to be swung to a position parallel to the body wall.

Related, the latch can be snap closed as the user applies pressure to the closing element to force the latch edge to clear the lock flange face and be retained by the lock edge.

According to a still further advantage of the present invention, the retainer is offset from the body plane. This advantageously allows for a user to access the latch and the retainer from in front of the plane of the body wall. No access to a perpendicular body side is required to open and close the mountable structure.

According to further advantage of the present invention, the lock edge is on the internal side of the retainer. This allows the user to press the mountable structure closed from the internal side of the retainer.

According to a still further advantage of the present invention, cam locks can be used to secure the mountable structure in a closed position.

According to a still further advantage yet of the present invention, a lock passage is formed between the lock flange and the guide, which allows an external lock to be attached to the tub to prevent the mountable structure from being able to be opened as the latch cannot be removed from the retainer.

According to a still further advantage of the present invention, the mountable structure is easily opened by the user with one hand. This can be accomplished by the user squeezing the thumb pad of the retainer and the release element of the latch to allow the latch edge to clear the lock edge as the user pulls outward on the engagement element to open the mountable structure.

According to a still further advantage yet of the present invention, the mountable structure has a depth that is approximately in plane with the inside of the tub when the mountable structure is closed. This advantageously makes the mountable structure more secure when closed.

According to another advantage of the present invention, the tubs can be injection molded and be nested for shipping and/or storage. The frames are easy to assembly and the accessories such as mountable structures are easy to interchange.

According to a further advantage yet of the present invention, the frame covers the perimeter edge of the tub opening so that the animals cannot escape between the tub and frame.

According to a still further advantage yet of the present invention, a variety of types of mountable structures could be used. For example, the structure could alternatively be a feeder with one or more bowls.

Other advantages, benefits, and features of the present invention will become apparent to those skilled in the art upon reading the detailed description of the invention and studying the drawings.

### BRIEF DESCRIPTION OF DRAWINGS

FIG. 1 is a perspective view of a preferred embodiment of a tub.

FIG. 2 is an end view of the embodiment of a tub illustrated in FIG. 1.

FIG. 3 is a side view of the embodiment of a tub illustrated in FIG. 1.

FIG. 4 is a top view of the embodiment of a tub illustrated in FIG. 1.

FIG. 5 is a bottom view of the embodiment of a tub illustrated in FIG. 1.

FIG. 6 is a close-up upper perspective view showing a mountable structure secured to a frame with mountable structure pins received within mountable structure frame barrels.

FIG. 7 is a close-up lower perspective view showing a mountable structure secured to a frame with mountable structure pins received within frame barrels.

FIG. 8 is a close-up perspective view of a portion of a mountable structure and mountable structure frame showing mountable structure pins and mountable structure frame barrels.

FIG. 9 is a close-up perspective view showing a mountable structure secured to a mountable structure frame with mountable structure latch being secured by the mountable structure frame retainer.

FIG. 10 is an alternative close-up perspective view showing a mountable structure secured to a mountable structure frame with mountable structure latch being secured by the mountable structure frame retainer.

FIG. 11 is a perspective view showing the mountable structure in an open position.

FIG. 12 is a cross-sectional view showing the latch coming into contact with the lock as the mountable structure is being closed.

FIG. 13 is a perspective view showing the lock edge engaging the latch edge while the mountable structure is in the closed position.

FIG. 14 is a close-up perspective view showing optional cam locks positioned to the lock position.

FIG. 15 is a close-up perspective view showing an optional lock passing through the lock passage to maintain a closed position of the mountable structure.

FIG. 16 is a cross-sectional view showing the lock flange disengaged from the latch so that the mountable structure is openable.

FIG. 17 is a close-up perspective view showing the mountable structure opening.

FIG. 18 is a perspective view showing the mountable structure in an open position.

FIG. 19 is an isolation perspective view of the body

FIG. 20 is a perspective view of a preferred embodiment of a mountable structure frame inner piece.

FIG. 21 is a reverse perspective view of the mountable structure frame inner piece of FIG. 20.

FIG. 22 is a perspective view of a preferred embodiment of a mountable structure frame outer piece.

FIG. 23 is a reverse perspective view of the mountable structure frame outer piece of FIG. 22.

FIG. 24 is a top view of the mountable structure frame outer piece of FIG. 22.

FIG. 25 is a close-up perspective view of the mountable structure frame retainer.

FIG. 26 is a perspective view of a preferred embodiment of a mountable structure.

FIG. 27 is a reverse perspective view of the mountable structure of FIG. 26.

FIG. 28 is a close-up perspective view of the latch.

FIG. 29 is a reverse close-up perspective view of the latch of FIG. 28.

FIG. 30 is a perspective view of an alternative mountable structure frame outer piece.

FIG. 31 is a perspective view of an alternative mountable structure frame inner piece.

FIG. 32 is a perspective view of an alternative mountable structure.

### DETAILED DESCRIPTION OF THE INVENTION

While the invention will be described in connection with one or more preferred embodiments, it will be understood that it is not intended to limit the invention to those embodiments. On the contrary, it is intended to cover all alternatives, modifications and equivalents as may be included within the spirit and scope of the invention as defined by the appended claims.

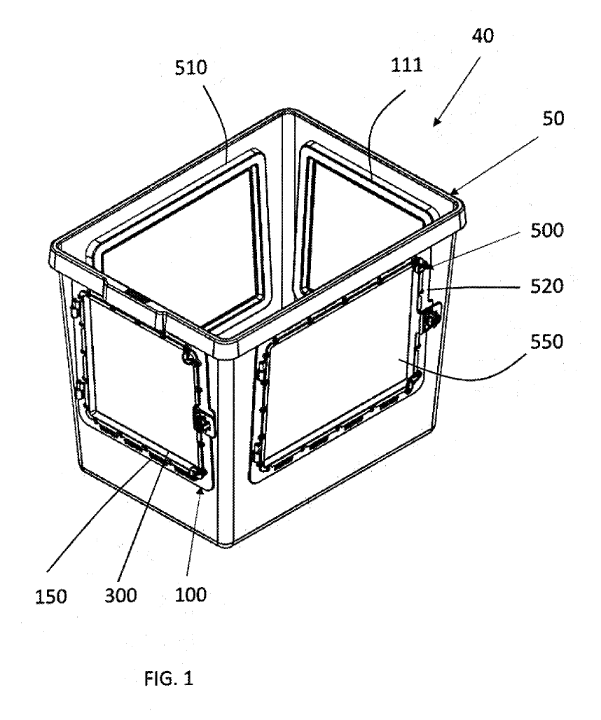

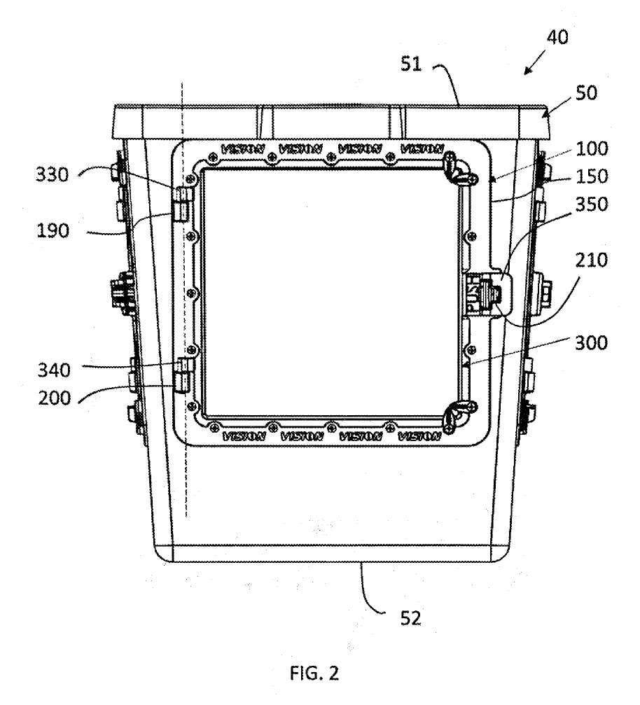

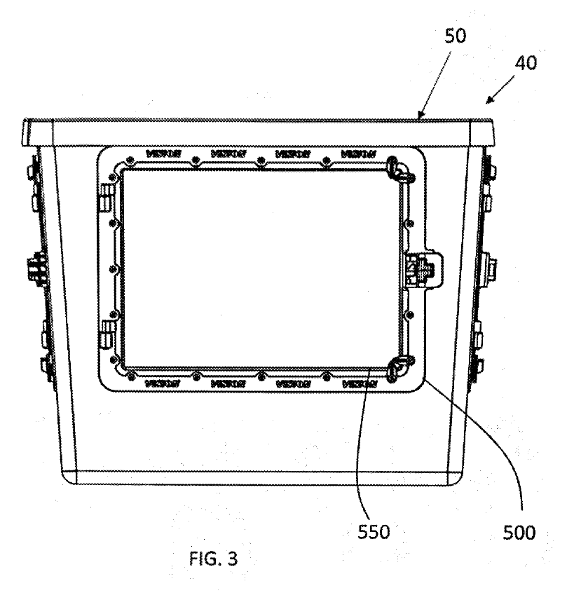

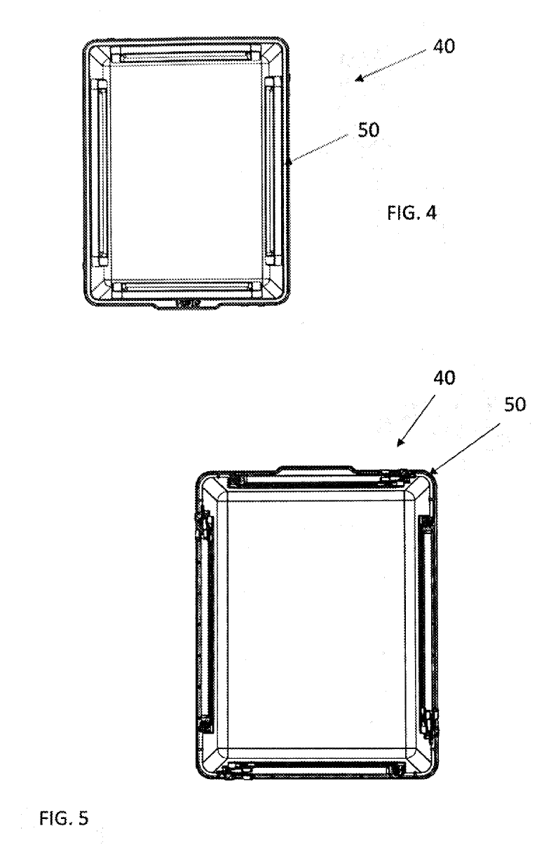

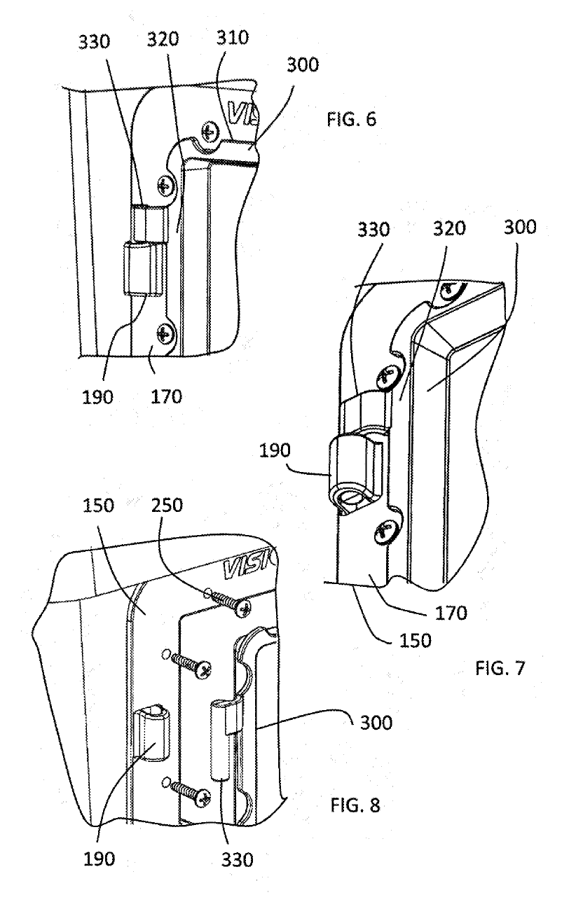

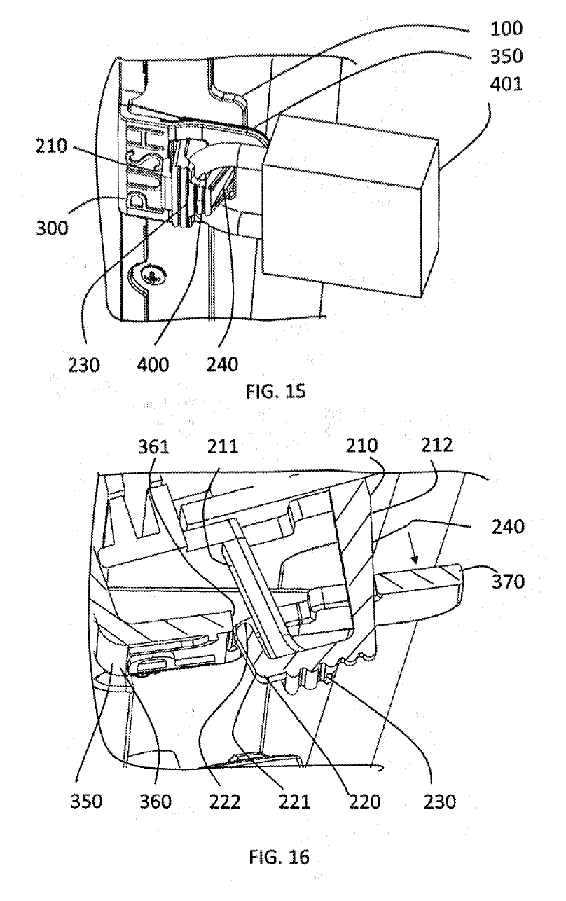

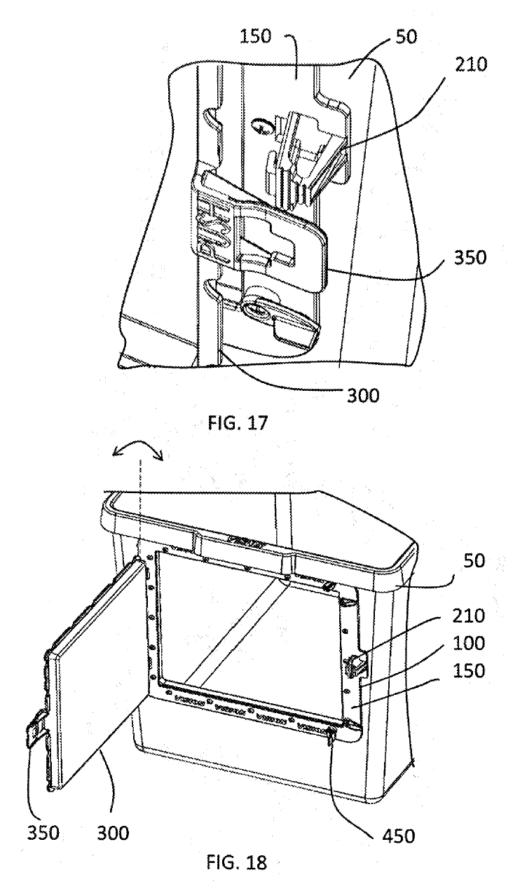

A preferred embodiment of a tub 40 is illustrated in FIGS. 1-18. The tub 40 has a body 50, at least one frame 100 and at least one mountable structure 300. Each of these components are described below.

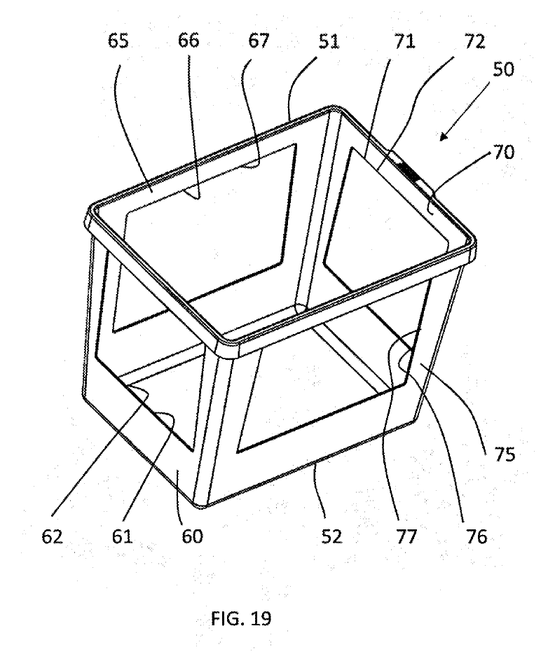

The body 50 is illustrated in isolation in FIG. 19. The body 50 has a top 51 and a bottom 52. The top 51 is preferably an open top that can be sealed with a lid (not shown). The body 50 preferably has four sidewalls 60, 65, 70 and 75. Each of the sidewalls can have an opening therethrough. Sidewall 60 can have an opening 61 therethrough with the opening having a generally rectangular perimeter 62. Sidewall 65 can have an opening 66 therethrough with the opening having a generally rectangular perimeter 67. Sidewall 70 can have an opening 71 therethrough with the opening having a generally rectangular perimeter 72. Sidewall 75 can have an opening 76 therethrough with the opening having a generally rectangular perimeter 77. It is appreciated that a tub 40 can have a body 50 with between one and four openings without departing from the broad aspects of the present invention.

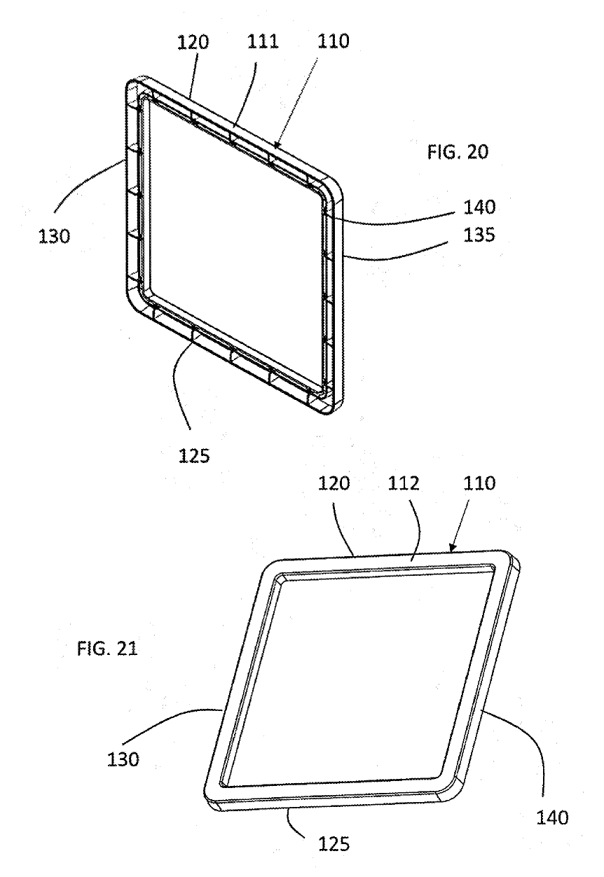

Turning now to FIGS. 20 and 21, it is seen that a preferred embodiment of a frame inner piece 110 is illustrated. Inner piece 110 has an inner surface 111 and an outer surface 112. Inner piece 110 further has a top 120, a bottom 125, a side 130 and a second side 135. Fastener holes 140 are provided and extend through the inner piece 110 about its perimeter.

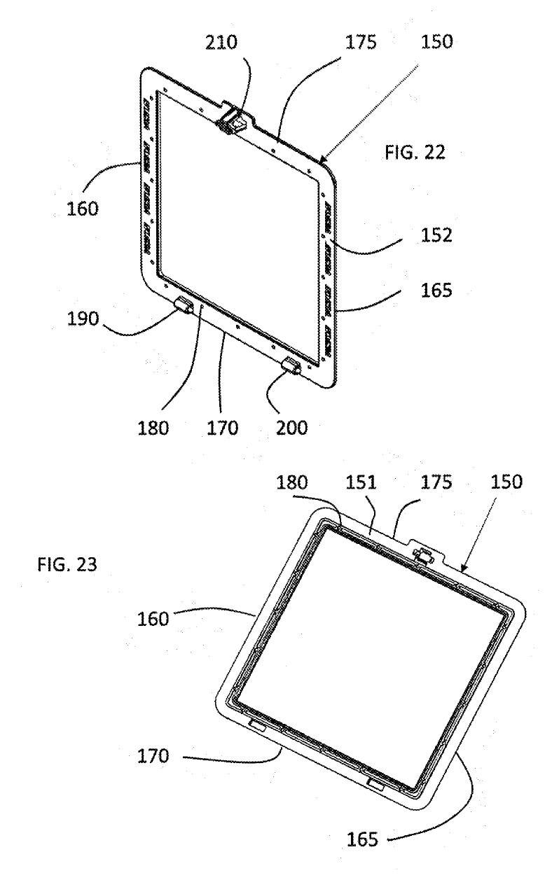

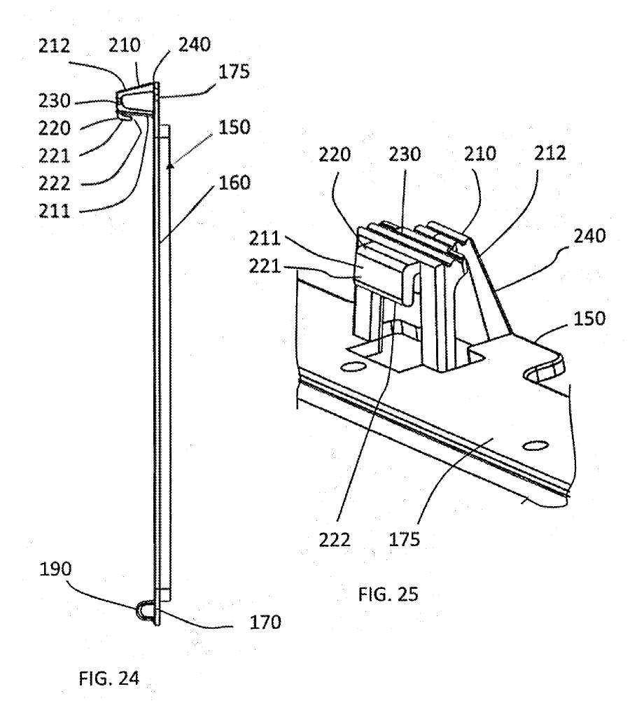

Turning now to FIGS. 22-25, it is seen that a preferred embodiment of a frame outer piece 150 is illustrated. The outer piece 150 has an inner surface 151 and an outer surface 152. Outer piece 150 further has a top 160, a bottom 165, a side 170 and a second side 175. Fastener holes 180 are provided and extend through the outer piece 150 about its perimeter.

Preferably there are two barrels 190 and 200 that extend forward from the outer surface 152 on side 170. Each barrel 190 and 200 has a central passage with a respective passage axis. The passage axis of each central passage is preferably linearly aligned with each other (i.e., are colinear).

A retainer 210 preferably extends forward from the outer surface 152 on side 175 of the outer piece 150. The retainer has a first side 211 (inner or interior side) and a second side 212 (outer or exterior side). A lock flange 220 is on the interior side 211 of the retainer 210. The lock flange 220 has a face 221 and an edge 222. There is a thumb pad on the distal end of the retainer 210 (farthest from the outer surface 152). A guide 240 is on the outer side 212 of the retainer.

The inner piece 110 and outer piece 150 are fastened together, as illustrated in FIGS. 1-3 and 6-8. This is accomplished with fasteners 250 such as screws being used with aligned fastener holes 140 and 180. It is appreciated that the inner surface 111 of the inner piece 110 and the inner surface 151 of the outer piece 150 both contact the sidewall 60 (for example) of the body 50.

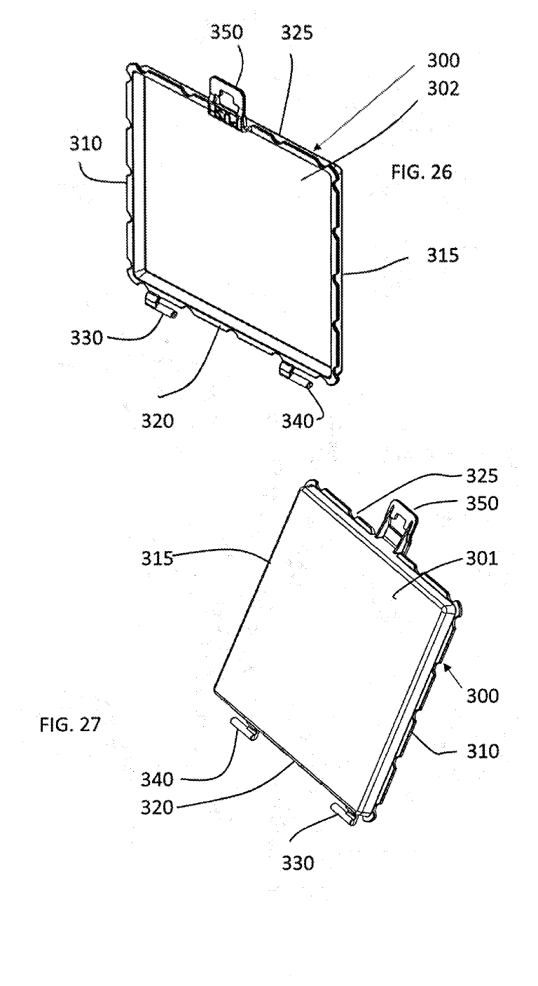

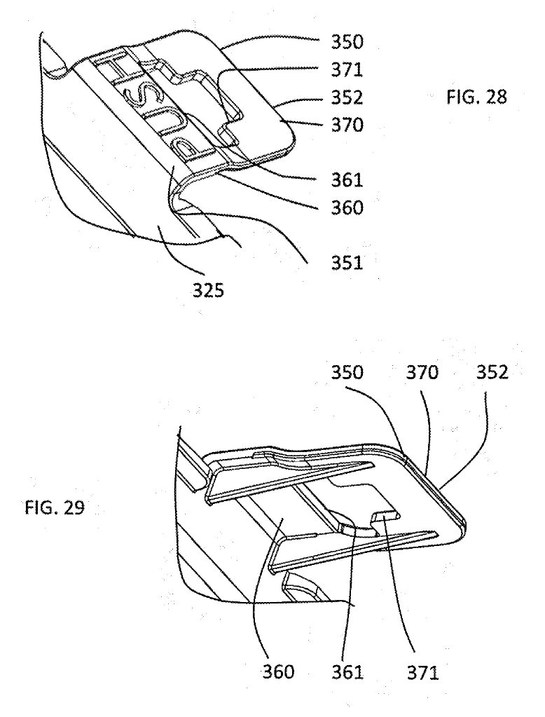

Turning now to FIGS. 26-29, it is seen that a preferred embodiment of a mountable structure 300, such as a door, is illustrated. It is appreciated that while a door is illustrated as one type of mountable structure, that the door could be exchanged for a different mountable structure with a different purpose and/or function without departing from the broad aspects of the present invention. The mountable structure 300 has an inner surface 301 and an outer surface 302. Mountable structure 300 further has a top 310, a bottom 315, a side 320 and a second side 325. The central portion of the mountable structure 300 is recessed.

It is preferred that there are two pins 330 and 340, respectively, that are located forward of the outer surface and outside of side 320. Pins 330 and 340 are preferably integral parts of the supported structure. Each pin 330 and 340 is connected to the outer surface 302 at the respective pin top. Each pin 330 and 340 has a longitudinal axis. The longitudinal axis of each pin is preferably linearly aligned (i.e., is colinear).

A latch 350 is on side 352 and projects forward from the outer surface 302 of the mountable structure. The latch has a first side 351 (inner or interior side) and a second side 352 (outer or exterior side). A closing element 360 is on the interior side 351 of the latch 350. The closing element 360 has a latch edge 361. A release element 370 is on the outer side 352 of the latch 350.

Turning now to FIGS. 9-18, various aspects of the interaction between the frame 100 and mountable structure 300 are illustrated.

The mountable structure 300 is supported by the frame 100. Specifically, pin 330 is received with barrel 190, and pin 340 is received within barrel 200. The weight of the structure 300 assists in keeping the structure mounted to the frame 100. The mountable structure 300 is removable from the frame 100 without tools by moving the mountable structure, when in the open position, vertically upward relative to the frame so that the pins are removed from the barrels. It is appreciated that the mountable structure 300 can swing relative to the frame 100. In this regard, the barrels 190 and 200, and the pins 330 and 340, are a hinge that allow the mountable structure to swing about a hinge axis of rotation. The hinge is preferably offset from the front plane of the body 50 thereby allowing the supported structure 300 to be able to swing to fully seat within the frame 100 as the mountable structure 300 is parallel to the body wall.

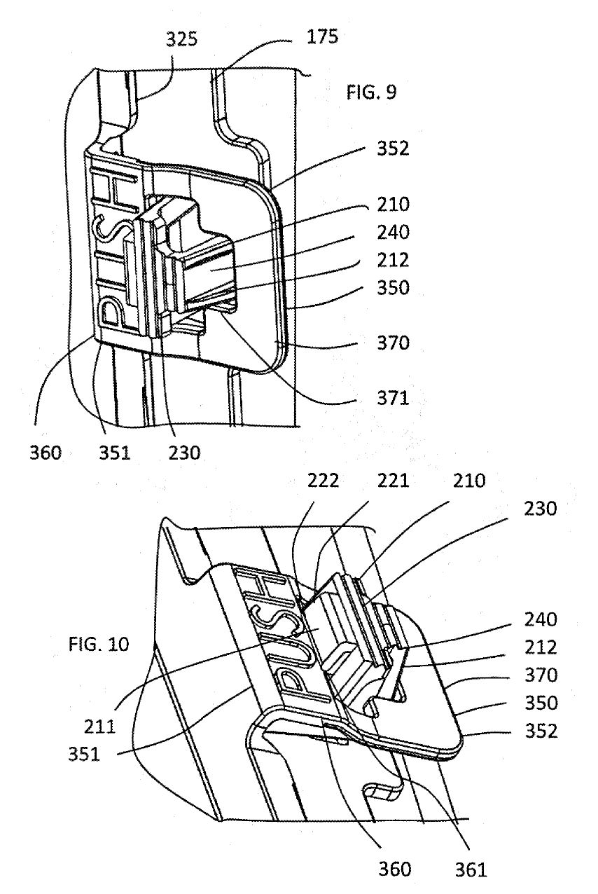

The mountable structure 300 can be in a closed position when the latch 350 is retained by the retainer 210, as seen in FIGS. 9 and 10. The user can force the mountable structure to the closed (or fixed) position by forcing the side 325 towards the frame 100 so that the closing element 310 is engaged by the lock flange 220. Specifically, the edge 222 of the lock flange 220 engages the latch edge 361 of the closing element 360 to hole the mountable structure 300 in the closed position.

The mountable structure 300 can be moved to an open position by having the lock flange edge 222 disengage from the latch edge 361. FIGS. 16-18 illustrates a sequence of opening the mountable structure 300. This can be accomplished by having the user engage the thumb pad 230 with their thumb and using a finger to engage the release element 370 to force the lock flange edge 222 to disengage from the latch edge 361, wherein the user then used the release element 370 to swing the mountable structure about the hinge to separate the latch 350 from the retainer 210.

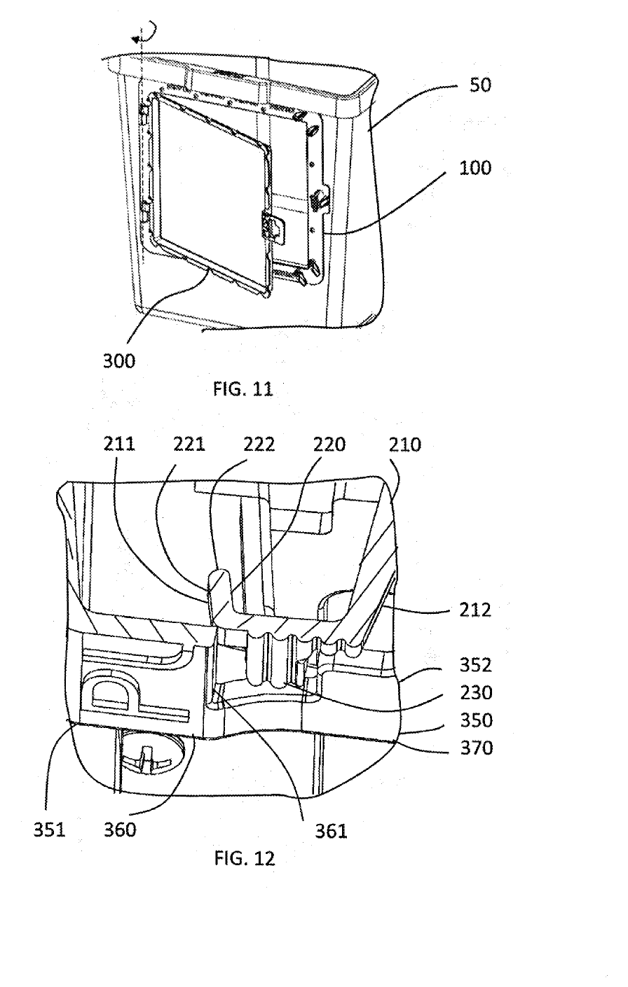

It is further seen in FIGS. 10 and 11 that the release element 370 has a channel 371. The channel accommodates the guide 240 of the retainer 210.

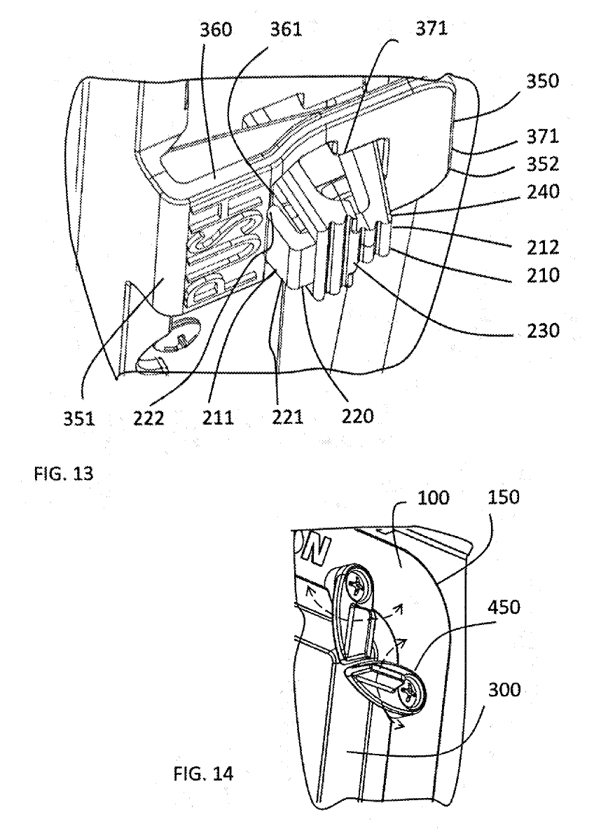

Turning now to FIG. 14, it is seen that cam locks 450 can be used to lock the mountable structure 300 in the closed position. The cam locks 450 can be rotated between lock positions (actively engaging the mountable structure, as seen in FIG. 14) and unlocked positions (where they do not engage the mountable structure).

Turning now to FIG. 16 it is seen that a lock passage 400 can be formed between the retainer sides 211 and 212, specifically between the lock flange 220 and the guide 240. When the mountable structure 300 is in the closed position, a lock such as a padlock 401 can be placed through the passage 400 to lock the mountable structure in the closed position so that the latch 350 cannot be disengaged from the retainer 210.

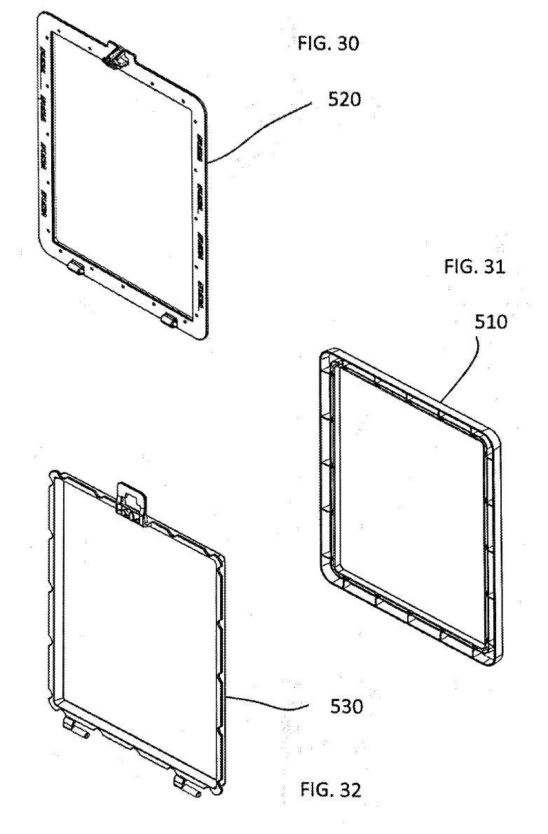

Turning now to FIGS. 30-32, it is seen that larger sizes of an inner piece 510 and an outer piece 520 of a frame 500, as well as a mountable structure 530, are illustrated. These components operate similarly to frame 100 and mountable structure 300, but are sized differently and can be used on a long side of the body 50.

It is appreciated that other mountable structures other than a mountable structure can be used with the present invention. For example, the structure could be a feeder. Hence, the mountable structures are interchangeable.

It is appreciated that there are several unique structural features according to various aspects of the present invention. These features can be utilized individually or combined with other features in any possible way, such as being coupled with other features, tripled with other features and/or used all together without departing from the broad aspects of the present invention.

For example, the tub can comprise:

a body having a top and a bottom, the body comprising a sidewall, the sidewall having an opening therethrough;

a frame, the frame being secured to the sidewall, the frame comprising a barrel; and

a mountable structure that is selected mounted to the frame, the mountable structure having a pin, the pin being selectably insertable into the barrel to secure the mountable structure to the frame in a swingable manner.

For further example, the tub can comprise:

a body having a top and a bottom, the body comprising a sidewall, the sidewall having an opening therethrough;

a frame, the frame being secured to the sidewall, the frame comprising a retainer, the retainer comprising a lock flange; and

a mountable structure that mounted to the frame, the mountable structure comprising a latch, the latch having an internal side and an external side and comprising a closing element, the closing element being on the internal side,

wherein the mountable structure is in a closed position when the latch is retained by the retainer and the mountable structure is in an open position when the latch is unretained by the retainer.

It is further appreciated that there are several unique method features according to the present invention. These features can be utilized individually or combined with other features in any possible way, such as being coupled with other features, tripled with other features and/or used all together without departing from the broad aspects of the present invention.

Thus, it is apparent that there has been provided, in accordance with the invention, a tub with interchangeable mountable structures that fully satisfies the objects, aims and advantages as set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

1. A tub comprising:
a body having a top and a bottom, the body comprising a sidewall, the sidewall having an opening therethrough;
a frame, the frame being secured to the sidewall, the frame comprising a barrel; and
a mountable structure that is selected mounted to the frame, the mountable structure having a pin, the pin being selectably insertable into the barrel to secure the mountable structure to the frame in a swingable manner.

2. The tub of claim 1 wherein:
the barrel is a first barrel and the frame further comprises a second barrel, the second barrel being aligned with the first barrel; and
the pin is a first pin and the mountable structure further comprises a second pin, the second pin being aligned with the first pin.

3. The tub of claim 2 wherein:
the first pin is selectably insertable into a first barrel top;
the second pin is selectably insertable into the second barrel top; and
the mountable structure is vertically supported by the frame.

4. The tub of claim 1 wherein the frame comprises an inner piece and an outer piece, the barrel being on the outer piece.

5. The tub of claim 4 wherein the barrel has a pivot axis, the pivot axis being offset from the sidewall.

6. The tub of claim 1 wherein:
the frame further comprises a retainer;
the mountable structure further comprises a latch; and
the mountable structure is in a closed position when the latch is retained by the retainer and the mountable structure is in an open position when the latch is unretained by the retainer, the mountable structure being able to be selectably rotated about the pin when the mountable structure is in the unlocked position.

7. The tub of claim 6 wherein:
the retainer comprises a lock flange;
the latch comprises a closing element; and
the lock flange retains the closing element when the mountable structure is in the closed position.

8. The tub of claim 7 wherein the latch further comprises a release element.

9. The tub of claim 8 wherein the retainer further comprises a thump pad, the thumb pad and the release element being simultaneously engaged to unlock the mountable structure.

10. The tub of claim 7 wherein the retainer comprises a lock passage.

11. A tub comprising:
a body having a top and a bottom, the body comprising a sidewall, the sidewall having an opening therethrough;
a frame, the frame being secured to the sidewall, the frame comprising a retainer, the retainer comprising a lock flange; and
a mountable structure that mounted to the frame, the mountable structure comprising a latch, the latch having an internal side and an external side and comprising a closing element, the closing element being on the internal side,
wherein the mountable structure is in a closed position when the latch is retained by the retainer and the mountable structure is in an open position when the latch is unretained by the retainer.

12. The tub of claim 11 wherein the latch further comprises a release element, the release element being on the external side of the latch.

13. The tub of claim 12 wherein the retainer further comprises a thump pad, the thumb pad and the release element being simultaneously engaged to unlock the mountable structure.

14. The tub of claim 11 wherein the retainer comprises a lock passage.

15. The tub of claim 11 wherein:
the frame further comprises a barrel; and
the mountable structure further comprises a pin, the pin being selectably insertable into the barrel to secure the mountable structure to the frame in a swingable manner.

16. The tub of claim 15 wherein:
the barrel is a first barrel and the frame further comprises a second barrel, the second barrel being aligned with the first barrel; and
the pin is a first pin and the mountable structure further comprises a second pin, the second pin being aligned with the first pin.

17. The tub of claim 15 wherein:
the first pin is selectably insertable into a first barrel top;
the second pin is selectably insertable into the second barrel top; and
the mountable structure is vertically supported by the frame.

18. The tub of claim 15 wherein the frame comprises an inner piece and an outer piece, the barrel being on the outer piece.

19. The tub of claim 18 wherein the barrel has a pivot axis, the pivot axis being offset from the sidewall.

20. A tub comprising:
a body having a top and a bottom, the body comprising a sidewall, the sidewall having an opening therethrough;
a frame, the frame being secured to the sidewall, the frame comprising a first barrel, a second barrel and a retainer comprising a lock flange; and
a mountable structure that is selected mounted to the frame, the mountable structure having a first pin and a second pin, the first pin being selectably insertable into the first barrel and the second pin being selectably insertable into the second barrel to secure the mountable structure to the frame in a swingable manner, the mountable structure further comprising a latch, the latch having an internal side and an external side and comprising a closing element, the closing element being on the internal side,
wherein the mountable structure is in a closed position when the latch is retained by the retainer and the mountable structure is in an open position when the latch is unretained by the retainer.
